(19) United States
(12) Patent Application Publication
(10) Pub. No.: US 2009/0178133 A1
(43) Pub. Date: Jul. 9, 2009

(54) ELECTRONIC SYSTEM WITH ACCESS CONTROL

(76) Inventors: Michael Smith, Mesa, AZ (US); Paul Garcia, Mesa, AZ (US)

Correspondence Address: SCHMEISER OLSEN & WATTS, 18 E UNIVERSITY DRIVE, SUITE # 101, MESA, AZ, 85201, US

(21) Appl. No.: 11/971,348

(22) Filed: Jan. 9, 2008

(51) Int. Cl. G06F 13/00

(52) U.S. Cl. 726/16

(57) ABSTRACT

An electronic system includes an input device and an electronic device, and a switching device connected between them. The switching device allows and disallows access of the input device to the electronic device in response to a security signal. The input device is connected to the electronic device when the switching device is activated. The input device is disconnected from the electronic device when the switching device is deactivated.

### BACKGROUND OF THE INVENTION

1. Field of the Invention

This invention relates to an electronics system with restricted access.

2. Description of the Related Art

It is often desirable to provide security to an electronic system by restricting access to it. By restricting access to the electronic system, its unauthorized use is prevented. Restricted access to the electronic system can be provided in many different ways. For example, the electronic system often includes a controller in communication with an input device. Access is provided to the controller in response to a predetermined access input signal being provided to the controller through the input device.

There are many different ways the predetermined access input signal can be provided to the controller. For example, the input device can be a computer system operating security software. The predetermined access input signal is then provided to the security software as a username and password. The input device can also be a biometric device which receives biometric data, such as fingerprint and retina scan information. The predetermined input signal is provided in response to biometric data being provided to the controller with the biometric device.

Another way restricted access can be provided to the electronic system is with a keypad in communication with the controller. The keypad restricts access to the electronic system until a predetermined key input is provided to the controller through the keypad. An example of an electronic system with a keypad is disclosed in U.S. Pat. No. 6,260,765. However, it is often possible to circumvent the security provided by these input devices to gain unauthorized access to the electronic system.

### BRIEF SUMMARY OF THE INVENTION

The present invention employs a switching device which controls the communication between electronic and input devices. When the switching device is activated, the electronic and input devices are in communication with each other, and a digital control signal is allowed to flow between them. The digital control signal is used to control the operation of the electronic device. The operation of the electronic device can be controlled by the input device if the digital control signal is received by the electronic device.

When the switching device is deactivated, the electronic and input devices are not in communication with each other, and the digital control signal is not allowed to flow between them. The operation of the electronic device cannot be controlled by the input device unless the digital control signal is received by the electronic device. The switching device is activated and deactivated in response to a security signal. In this way, security is provided to the electronic device by controlling the communication between it and the input device.

These and other features, aspects, and advantages of the present invention will become better understood with reference to the following drawings and description.

### BRIEF DESCRIPTION OF THE DRAWINGS

FIG. 1 is a block diagram of an electronic system which includes electronic and input devices in communication with each other through a switching device, in accordance with the invention.

FIG. 2 is a block diagram of the electronic system of FIG. 1 with a security system in communication with the switching device.

FIG. 3 is a block diagram of an electronic system, in accordance with the invention, wherein the input and switching devices are integrated together.

FIGS. 4, 5, 6 and 7 are block diagrams of the electronic system of FIG. 1, wherein the input device is embodied as a thermostat with a keypad processor, and the electronic device is embodied as a main thermostat processor.

FIG. 8 is a block diagram showing an electronic system, in accordance with the invention, which includes a computer input device in communication with a computer system through a relay.

FIG. 9 is a block diagram showing an electronic system, in accordance with the invention, which includes a keyboard and mouse in communication with a computer system through separate relays.

### DETAILED DESCRIPTION OF THE INVENTION

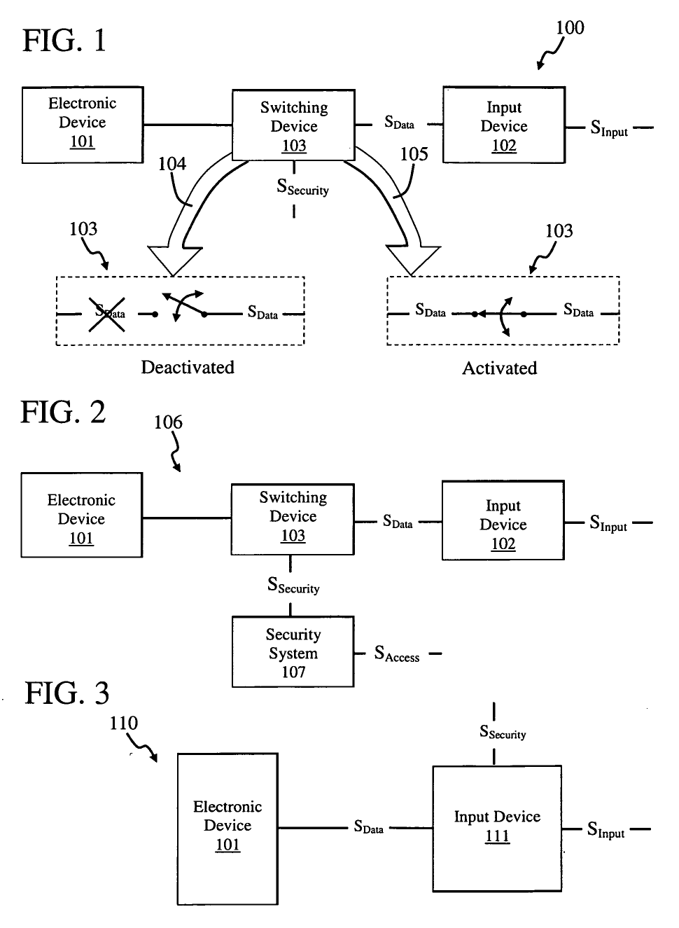

FIG. 1 is a block diagram of an electronic system 100, in accordance with the invention. In this embodiment, electronic system 100 includes a switching device 103 connected between an input device 102 and an electronic device 101. In accordance with the invention, switching device 103 allows and disallows, in response to a security signal S_{Security}, input device 102 to communicate with electronic device 101. Input device 102 can control the operation of electronic device 101 when input device 102 is allowed to communicate with electronic device 101. Further, input device 102 cannot control the operation of electronic device 101 when input device 102 is not allowed to communicate with electronic device 101.

Switching device 103 can be of many different types, such as a relay, key switch and filter. There are many different types of relays that can be used, such as those made by Zettler Automotive of Aliso Viejo, Calif. Further, there are many different types of filters that can be used, such as analog or digital filters. An analog filter generally includes analog circuit components, such as resistors, capacitors, transistors and/or operational amplifiers. A digital filter generally includes digital logic devices made from interconnected transistors.

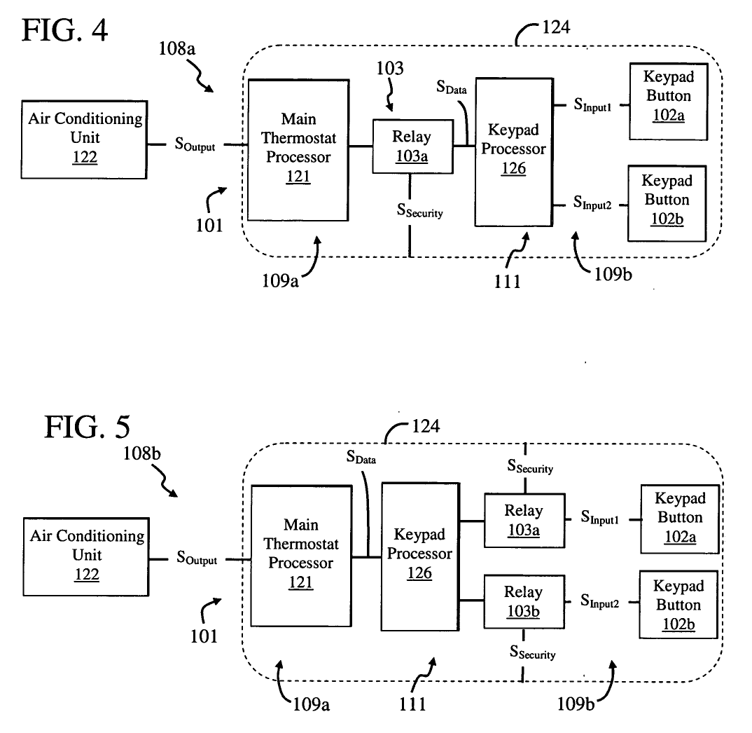

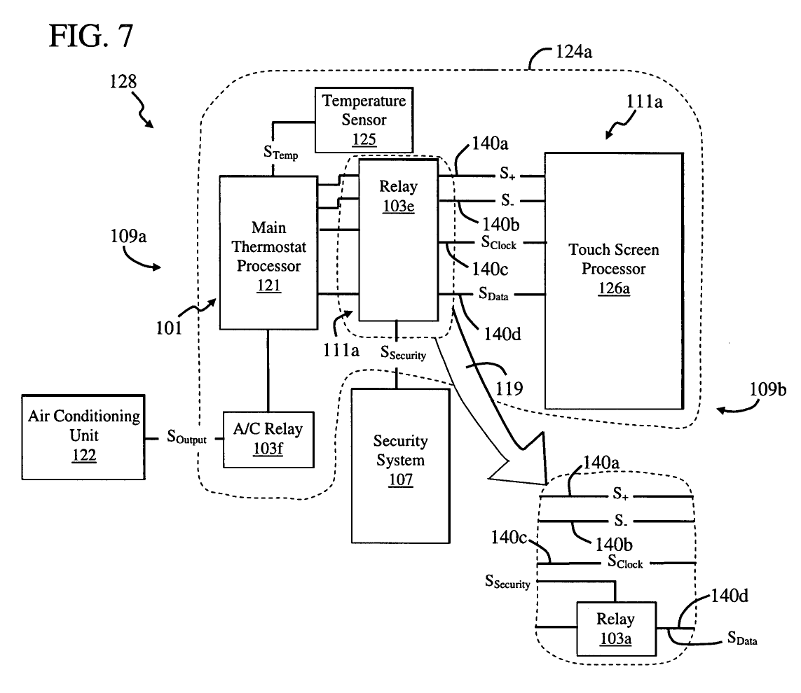

Electronic device 101 and input device 102 can be of many different types. For example, in an embodiment shown in FIGS. 4, 5, 6 and 7, electronic device 101 and input device 102 are embodied as components of a thermostat used to control the operation of an air conditioning unit. The input device of the thermostat generally includes a keypad processor connected to key buttons and the electronic device of the thermostat generally includes a thermostat processor. The operation of the thermostat processor is controlled in response to providing inputs to the keypad processor with the key buttons. Examples of thermostats for air conditioning systems are disclosed in U.S. Pat. Nos. 4,663,951, 4,969,508, 5,244,146, 5,361,982 and 6,619,055. It should be noted that, in some embodiments, the keypad processor and key buttons are replaced with a touch screen processor. One such embodiment is shown in FIG. 7.

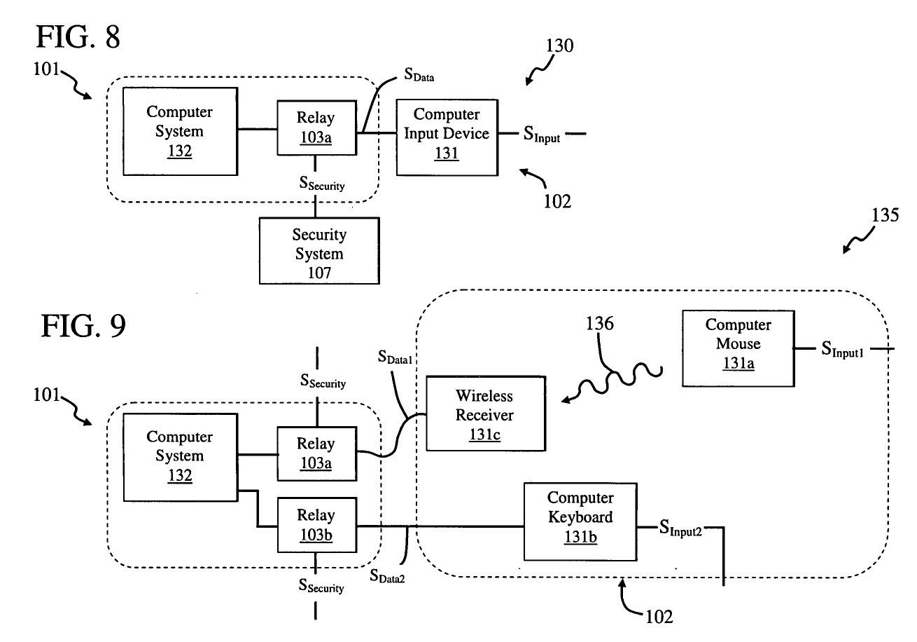

In an embodiment shown in FIGS. 8 and 9, electronic device 101 is embodied as a computer, and input device 102 is embodied as a computer input device. The computer input device can be a computer keyboard or computer mouse, and these input devices can be wired or wireless. Examples of computer keyboards are disclosed in U.S. Pat. Nos. 6,224,279 and 6,712,535 and examples of a computer mouse are disclosed in U.S. Pat. Nos. D438,209 and D437,599. It should be noted that electronic device 101 and input device 102 can be of many other types, which are not discussed herein for simplicity and ease of discussion.

Electronic device 101 operates in response to an input signal S_{Input} received by input device 102. For example, when input device 102 is a computer keyboard, input signal S_{Input} is received by input device 102 when a key on the keyboard is pushed. When input device 102 is a computer mouse, input signal S_{Input} is received by input device 102 when the mouse is moved. After input device 102 receives input signal S_{Input}, it outputs a digital control signal S_{Data}, wherein digital control signal S_{Data} is a digital signal. A digital signal generally includes information in a digital format, such as bits.

In accordance with the invention, digital control signal S_{Data} is allowed to flow between input device 102 and electronic device 101 when switching device 103 is activated. Further, digital control signal S_{Data} is not allowed to flow between input device 102 and electronic device 101 when switching device 103 is deactivated. When digital control signal S_{Data} is not allowed to flow between input device 102 and electronic device 101, access to electronic device 101 is restricted. In this way, the flow of digital control signal S_{Data} between input device 102 and electronic device 101 is controlled by switching device 103. The flow of control signal S_{Data} between input device 102 and electronic device 101 can be controlled in many different ways.

In one way, switching device 103 is embodied as a relay so that when it is activated, input device 102 is connected to electronic device 101, as indicated by an indication arrow 105. It should be noted that, in this embodiment, input device 102 is physically connected to electronic device 101 when switching device 103 is activated. In this way, input device 102 is physically connected to electronic device 101 in response to switching device 103 being activated and, in response, digital control signal S_{Data} is allowed to flow between them. The operation of electronic device 101 can be adjusted, in response to receiving digital control signal S_{Data}, by using input device 102 to adjust digital control signal S_{Data}.

When the relay is deactivated, input device 102 is disconnected from electronic device 101, as indicated by an indication arrow 104. It should be noted that, in this embodiment, input device 102 is physically disconnected from electronic device 101 when switching device 103 is deactivated. In this way, input device 102 is physically disconnected from electronic device 101 in response to switching device 103 being deactivated and, in response, digital control signal S_{Data} is not allowed to flow between them. The operation of electronic device 101 cannot be adjusted, in response to receiving digital control signal S_{Data}, by using input device 102 to adjust digital control signal S_{Data}.

In another way, switching device 103 is embodied as a filter, such as a digital or analog filter. When the filter is activated, digital control signal S_{Data} flows therethrough and is amplified. Digital control signal S_{Data} is amplified by the filter so that the operation of electronic device 101 can be adjusted in response to receiving it. When the filter is deactivated, digital control signal S_{Data} flows therethrough and is attenuated. Digital control signal S_{Data} is attenuated by the filter so that the operation of electronic device 101 can not be adjusted in response to receiving it.

It should be noted that, in this embodiment, the filter scales digital control signal S_{Data} by amplifying or attenuating its amplitude. However, in some situations, the amplitude of digital control signal S_{Data} is scaled by a factor of one or approximately one. Filters that scale the amplitude of a signal by one or approximately one are often referred to as unity gain filters.

It should also be noted that switching device 103 can be activated and deactivated in many different ways. For example, it can be activated and deactivated in response to a security signal S_{Security}. In this way, security is provided to electronic device 101 by controlling the communication between it and input device 102 with security signal S_{Security}. In some embodiments, security signal S_{Security} is provided to switching device 103 through a wireless connection and, in other embodiments, it is provided through a wired connection. However, security signal S_{Security} is generally provided from a security system, as will be discussed in more detail presently.

FIG. 2 is a block diagram of an electronic system 106, wherein electronic system 106 includes electronic system 100 of FIG. 1. In accordance with the invention, electronic system 106 also includes a security system 107 which provides security signal S_{Security} to switching device 103. In this way, security system 107 is in communication with switching device 103.

As discussed above, switching device 103 is activated and deactivated in response to security signal S_{Security}. It should be noted that security signal S_{Security} can correspond to many different signals to activate and deactivate switching device 103. In one example, switching device 103 is activated and deactivated when security signal S_{Security} corresponds to a digital one and zero, respectively. In another example, switching device 103 is activated and deactivated when security signal S_{Security} corresponds to a digital zero and one, respectively.

Security system 107 can be of many different types, such as a biometric or non-biometric security system. A biometric security system provides security signal S_{Security} in response to a biometric input signal, such as data corresponding to a person's finger, voice, eye pattern, etc. A non-biometric security system provides security signal S_{Security} in response to non-biometric input signal, such as data corresponding to signals from a keypad or a key lock. An example of a keypad is disclosed in U.S. Pat. Nos. 4,721,954 and 5,015,829. When security system 107 is a keypad, security signal S_{Security} is provided in response to activating one or more of its keypad buttons. When security system 107 is a key lock, security signal S_{Security} is provided in response to activating it with a corresponding key. It should be noted that the biometric and non-biometric input signal are indicated as signal S_{Access} in FIG. 2.

In this embodiment, however, security system 107 is a card reader so that security signal S_{Security} is provided to switching device 103 in response to the card reader reading a security card. An example of a card reader is disclosed in U.S. Pat. No. 6,223,984. In general, the card reader includes a microcontroller and the security card includes a microprocessor. However, the security card can include a magnetic strip in some embodiments. If the security card includes a microprocessor, the microprocessor of the security card flows signal S_{Access} to the microcontroller of the card reader when they are positioned proximate to each other. If the security card includes a magnetic strip, the microcontroller of the card reader reads security data, represented by signal S_{Access}, stored with the magnetic strip when the magnetic strip is moved relative to the card reader.

The security data included with signal S_{Access} is then processed and the microcontroller determines whether or not to activate or deactivate switching device 103 with security signal S_{Security}. This determination can be made in many different ways, such as by using a protocol, such as the RS-232 and RS-485 protocols. The RS-232 and RS-485 protocols are well-known and are often used to operate microcontrollers associated with card readers. Another protocol that can be used is based on the Universal Serial Bus (USB), which is often used for flowing a signal between a computer system and a USB compatible electronic device.

In one mode of operation, the security data collected by the microcontroller is checked and a decision is made by logic circuitry whether or not to flow security signal S_{Security} to switching device 103. The security data collected is often compared by the logic circuitry with the information stored with a microcontroller memory system.

If the security data collected matches that stored by the microcontroller memory system, switching device 103 is activated in response to security signal S_{Security}. In some situations when the security data matches, switching device 103 is in an activated condition and it remains there. In other situations when the security data matches, switching device 103 is in a deactivated condition and is moved to the activated condition.

If the security data collected does not match that stored by the microcontroller memory system, switching device 103 is deactivated in response to security signal S_{Security}. In some situations when the security data does not match, switching device 103 is in the deactivated condition and it remains there. In other situations when the security data does not match, switching device 103 is in the activated condition and is moved to the deactivated condition.

It should be noted that the security data can be stored with security system 107 or with an external database that security system 107 is in communication with. It should also be noted that input device 102 and switching device 103 are shown as being separate components in systems 100 and 106. However, they can be integrated together, as will be discussed in more detail presently.

FIG. 3 is a block diagram of an electronic system 110 which includes an input device 111 connected to electronic device 101. In accordance with the invention, the switching device (not shown) is included with input device 111 so that the input and switching devices are integrated together. In one mode of operation, the switching device included with input device 111 is activated in response to security signal S_{Security}. When the switching device included with input device 111 is activated, digital control signal S_{Data} is allowed to flow between input device 111, and the operation of electronic device 101 can be adjusted in response. In another mode of operation, the switching device included with input device 111 is deactivated in response to security signal S_{Security}. When the switching device included with input device 111 is deactivated, digital control signal S_{Data} does not flow between input device 111, and the operation of electronic device 101 can not be adjusted in response. It should be noted that the switching device can be included with input device 111 in many different ways, several of which will be discussed in more detail presently.

FIG. 4 is a block diagram of an electronic system 108a, in accordance with the invention, wherein electronic system 108a includes an air conditioning unit 122 in communication with a thermostat 124. In this embodiment, thermostat 124 includes input device 111, which is embodied as a keypad processor 126 operatively coupled with keypad buttons 102a and 102b. Thermostat 124 includes electronic device 101, which is embodied as a main thermostat processor 121. Main thermostat processor 121 is in communication with air conditioning unit 122 and controls its operation by flowing an output signal S_{Output} to it. It should be noted that signal S_{Output} is generally an analog signal.

In accordance with the invention, thermostat 124 includes switching device 103, which is embodied as a relay 103a. Relay 103a is activated and deactivated in response to security signal S_{Security}, as discussed above with FIGS. 1 and 2. Keypad processor 126 is in communication with main thermostat processor 121 through relay 103a when relay 103a is activated. Keypad processor 126 is not in communication with main thermostat processor 121 through relay 103a when relay 103a is deactivated.

In one embodiment of operation, security signal S_{Security} is provided to relay 103a so it is activated and keypad processor 126 is connected to main thermostat processor 121. In this way, the operation of main thermostat processor 121 can be controlled by keypad processor 126 with control signal S_{Data}. The operation of keypad processor 126 is controlled through signals S_{Input1} and S_{Input2} provided by keypad buttons 102a and 102b, respectively. The use of keypad buttons 102a and/or 102b can control the operation of air conditioning unit 122 in many different ways, such as by controlling a temperature setting of main thermostat processor 121.

In this embodiment of operation, signal S_{Security} is provided to relay 103a so it is deactivated and keypad processor 126 is disconnected from main thermostat processor 121. In this way, the operation of main thermostat processor 121 cannot be controlled with keypad buttons 102a and/or 102b. Hence, access to the operation of air conditioning unit 122 and access to the temperature setting of thermostat 124 is controlled by activating and deactivating relay 103a.

FIG. 5 is a block diagram of an electronic system 108b, in accordance with the invention, wherein electronic system 108b includes air conditioning unit 122 in communication with thermostat 124. In this embodiment, thermostat 124 includes input device 111, which is embodied as keypad processor 126 operatively coupled with keypad buttons 102a and 102b through relays 103a and 103b, respectively. In this way, the switching device is included with input device 111 so that the input and switching devices are integrated together, as discussed above with FIG. 3. Thermostat 124 includes electronic device 101, which is embodied as main thermostat processor 121. Main thermostat processor 121 is in communication with air conditioning unit 122 and controls its operation.

In one embodiment of operation, when signal S_{Security} activates relays 103a and 103b, keypad buttons 102a and 102b are connected to keypad processor 126. In this way, the operation of main thermostat processor 121 can be controlled with keypad buttons 102a and/or 102b. In this embodiment of operation, when signal S_{Security} deactivates relays 103a and 103b, keypad buttons 102a and 102b are disconnected from keypad processor 126. In this way, the operation of main thermostat processor 121 cannot be controlled with keypad buttons 102a and/or 102b. Hence, access to the operation of air conditioning unit 122 is controlled by activating and deactivating relays 103a and 103b.

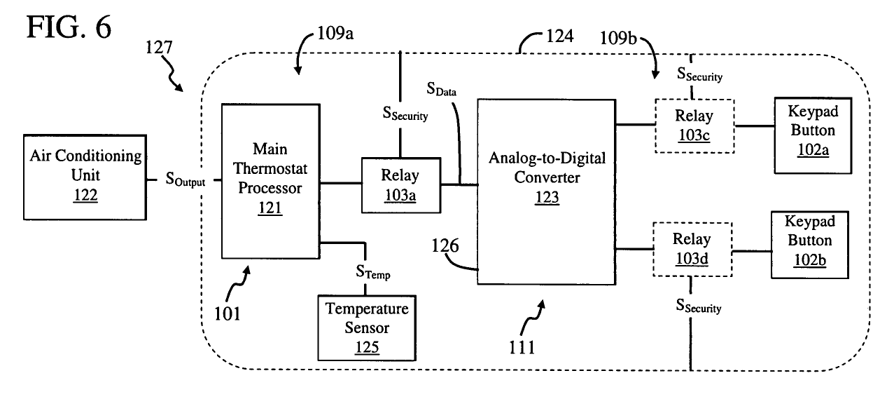

FIG. 6 is a block diagram of an electronic system 127, in accordance with the invention, wherein electronic system 127 includes air conditioning unit 122 in communication with thermostat 124. In this embodiment, thermostat 124 includes input device 111 having keypad processor 126 operatively coupled with keypad buttons 102a and 102b, wherein keypad processor 126 is embodied as an analog-to-digital (A/D) converter 123. A/D converter 123 can be of many types, such as those provided by MOTOROLA as Model No. 68HC05P8. More information regarding the use of these types of A/D converters in a thermostat is provided in U.S. Pat. No. 5,361,982.

Thermostat 124 includes electronic device 101, which is embodied as main thermostat processor 121 in communication with an internal temperature sensor 125. Main thermostat processor 121 is in communication with air conditioning unit 122 and controls its operation.

In accordance with the invention, thermostat 124 includes switching device 103, which is embodied as relay 103a. A/D converter 123 is in communication with main thermostat processor 121 through relay 103a when relay 103a is activated. A/D converter 123 is not in communication with main thermostat processor 121 when relay 103a is deactivated.

It should be noted that, in some embodiments, electronic system 127 includes relays 103c and 103d integrated with input device 111. In this embodiment, relays 103c and 103d are shown in phantom connected between A/D converter 123 and keypad buttons 102a and 102b, respectively. It should be noted that system 127 operates similar to system 108a (FIG. 4) when system 127 includes relay 103a, and system 127 operates similar to system 108b (FIG. 5) when system 127 includes relays 103c and 103d.

In this embodiment, internal temperature sensor 125 is in communication with and provides an ambient temperature value, denoted as signal S_{Temp}, to main thermostat processor 121. Thermostat processor 121 compares the ambient temperature value to a desired temperature value. Thermostat 121 operates air conditioning unit 122 to drive the difference between the ambient and desired temperature values to zero.

It should be noted that temperature sensor 125 can be located away from main thermostat processor 121 and thermostat 124. For example, temperature sensor 125 can be located so it is hidden and difficult to locate. By locating temperature sensor 125 away from processor 121, it is more difficult to adjust its operation in an unauthorized manner, such as with a heating pad. By locating temperature sensor 125 away from processor 121, it more difficult to control the operation of air conditioning unit 122 through unauthorized access to thermostat 121.

In one embodiment of operation, when signal S_{Security} activates relay 103a, A/D converter 123 is connected to main thermostat processor 121 and digital control signal S_{Input} is allowed to flow therebetween. In this way, the operation of main thermostat processor 121 can be controlled with keypad buttons 102a and/or 102b. In this embodiment of operation, when signal S_{Security} deactivates relay 103a, A/D converter 123 is disconnected from main thermostat processor 121 and digital control signal S_{Input} is not allowed to flow therebetween. In this way, the operation of main thermostat processor 121 cannot be controlled with keypad buttons 102a and/or 102b. Hence, the ability to control the operation of air conditioning unit 122 is controlled by activating and deactivating relay 103a.

It should be noted that in other embodiments, relay 103a is removed from electronic system 127 and keypad buttons 102a and 102b are operatively coupled with A/D converter 123 through relays 103c and 103d, respectively. In operation, when signal S_{Security} activates relays 103c and 103d, keypad buttons 102a and 102b, respectively, are connected to A/D converter 123. In this way, the operation of main thermostat processor 121 can be controlled with keypad buttons 102a and/or 102b. Further, when signal S_{Security} deactivates relays 103c and 103d, keypad buttons 102a and 102b, respectively, are disconnected from A/D converter 123. In this way, the control of the operation of main thermostat processor 121 with keypad buttons 102a and/or 102b is not allowed.

FIG. 7 is a block diagram of an electronic system 128, in accordance with the invention, wherein electronic system 128 includes air conditioning unit 122 in communication with a thermostat 124a. In this embodiment, thermostat 124a includes an input device 111a, which is embodied as a touch screen processor 126a. Examples of touch screen processors are disclosed in U.S. Pat. Nos. 7,050,046 and 7,098,897.

Thermostat 124a includes electronic device 101, which is embodied as main thermostat processor 121 in communication with internal temperature sensor 125. Main thermostat processor 121 is in communication with air conditioning unit 122 through an A/C relay 103f.

In accordance with the invention, thermostat 124 includes switching device 103, which is embodied as a relay 103e. Relay 103e is connected between main thermostat processor 121 and touch screen processor 126a. Touch screen processor 126a is in communication with main thermostat processor 121 through relay 103e when relay 103e is activated. Touch screen processor 126a is not in communication with main thermostat processor 121 when relay 103e is deactivated. Electronic system 128 includes security system 107 which provides security signal S_{Security} to relay 103e to activate and deactivate it.

Relay 103e can have many different numbers of inputs and outputs. However, in this embodiment, relay 103e has four inputs and four outputs. Conductive lines 140a, 140b, 140c and 140d extend between relay 103e and separate outputs of touch screen processor 126a. Separate outputs of relay 103e are connected to conductive lines 140a, 140b, 140c and 140d, respectively, when relay 103e is activated so that conductive lines 140a, 140b, 140c and 140d are connected to separate inputs of main thermostat processor 121. Further, separate outputs of relay 103e are not connected to conductive lines 140a, 140b, 140c and 140d, respectively, when relay 103e is deactivated so that conductive lines 140a, 140b, 140c and 140d are not connected to separate inputs of main thermostat processor 121.

However, it should be noted that relay 103e can have more or fewer inputs and outputs. Further, relay 103e can be replaced with one or more separate relays, such as relays 103a, 103b and 103c discussed above. One embodiment is indicated by an indication arrow 119, wherein relay 103a is connected to an output of touch screen processor 126a through conductive line 140d. Further, conductive lines 140a, 140b and 140c extend between separate outputs of touch screen processor 126a and separate inputs of main thermostat processor 121 and are not connected to relays. When relay 103a is activated, signal S_{Data} is allowed to flow between touch screen processor 126a and main thermostat processor 121. Further, when relay 103a is deactivated, signal S_{Data} is not allowed to flow between touch screen processor 126a and main thermostat processor 121.

Conductive lines 140a and 140b flow power signals S₊ and S₋, respectively, between touch screen processor 126a and main thermostat processor 121, wherein power signals S₊ and S₋ flow through relay 103a. Power signals S₊ and S₋ provide power to main thermostat processor 121. Conductive lines 140c and 140d flow clock and control signals S_{clock} and S_{Data}, respectively, between touch screen processor 126a and main thermostat processor 121. Clock signal S_{clock} provides timing information to main thermostat processor 121 and control signal S_{Data} is discussed above. Thermostat 124a includes main thermostat processor 121 in communication with air conditioning unit 122 through an air conditioning relay 103e.

In one embodiment of operation, when signal S_{Security} activates relay 103e, touch screen processor 126a is connected to main thermostat processor 121 and signals S₊, S₋, S_{clock}, and S_{Data} are allowed to flow therebetween. In this way, the operation of main thermostat processor 121 can be controlled by providing one or more inputs to touch screen processor 126a. In this embodiment of operation, when signal S_{Security} deactivates relay 103e, touch screen processor 126a is disconnected from main thermostat processor 121 and signals S₊, S₋, S_{clock} , and S_{Data} are not allowed to flow therebetween. In this way, the operation of main thermostat processor 121 cannot be controlled with touch screen processor 126a. Hence, access to the operation of air conditioning unit 122 is controlled by activating and deactivating relay 103e. Security system 107 and temperature sensor 125 operate in a way the same or similar to that discussed above.

It should be noted that, in some embodiments, one or more of conductive lines 140a, 140b and 140c can be connected to relays. The relays can be separate relays, wherein they include a single input and a single output, or they can include multiple inputs and multiple outputs. The activation and deactivation of these relays are used to control the flow of signals S_{clock}, S₊ and S₋ between touch screen processor 126a and main thermostat processor 121.

FIG. 8 is a block diagram showing an electronic 130, in accordance with the invention, which includes input device 102 in communication with a computer system 132 through relay 103a, wherein input device 102 is embodied as computer input device 131. Relay 103a can be positioned at many different locations, such as externally and internally with computer system 132. For example, relay 103a can be directly connected to the motherboard of computer system 132. However, in this embodiment, relay 103a is shown as being external to computer system 132 for simplicity.

In this embodiment, security system 107 is connected to relay 103a, as described in more detail above, and provides security signal S_{Security} thereto in response to predetermined security signal S_{Access}. Computer input device 131 can be of many different types, such as a computer keyboard and mouse. Computer input device 131 can be connected to computer 132 in many different ways, but an electrical cable is generally used. There are many different types of electrical cables which can be used, such as RS-232C, PS/2, ADB or USB cables.

In operation, when the predetermined input is provided to security system 107, signal S_{Security} is provided to relay 103a. In response, relay 103a is activated and provides a physical connection between computer input device 131 and computer 132 so that a signal S_{Data} can flow therebetween. In this way, when computer input device 131 receives an input signal S_{Input}, such as a keystroke on a keyboard, computer input device 131 provides a control signal S_{Data} to computer 132 through relay 103a. When the predetermined input is not provided to computer input device 131, signal S_{Security} is not provided to relay 103a. In response, relay 103a is deactivated and computer input device 131 and computer 132 are disconnected from each other so that signal S_{Data} cannot flow therebetween. In this way, when computer input device 131 receives an input signal S_{Input}, such as a keystroke on a keyboard, computer input device 131 does not provide a control signal S_{Data} to computer system 132 through relay 103a. Hence, computer input device 131 cannot control the operation of computer system 132 unless switching device 103 is activated. It should be noted that signal S_{Data} is a digital signal so that when relay 103a is deactivated, computer input device 132 and computer system 132 are not in digital communication with each other. It should also be noted that computer input device 131 may be a wireless device, as will be discussed presently.

FIG. 9 is a block diagram showing an electronic system 135, in accordance with the invention, which includes input device 102 in communication with a computer system 132 through relays 103a and 103b, wherein input device 102 is embodied as computer input system 135. In this embodiment, computer input system 135 includes computer keyboard 131b and computer mouse 131a, as discussed above. In accordance with the invention, computer mouse 131a and computer keyboard 131b are in digital communication with computer system 132 through relays 103a and 103b, respectively.

Keyboard 131b and mouse 131a can be in communication with computer 132 in many different ways. In this embodiment, mouse 131a is in communication with computer system 132 through a wireless receiver 131c and relay 103a so that control signal S_{Data1} can flow therebetween. Control signal S_{Data1} flows through relay 103a between computer system 132 and wireless receiver 131c in response to wireless receiver 131c receiving a wireless mouse signal 136. Control signal S_{Data1} is allowed to flow between computer system 132 and wireless receiver 131c when relay 103a is activated. Control signal S_{Data1} is disallowed from flowing between computer system 132 and wireless receiver 131c when relay 103a is deactivated.

In this embodiment, keyboard 131b is in communication with computer system 132 through relay 103b by using an electrical cable so that a control signal S_{Data2} can flow therebetween. Control signal S_{Data2} is allowed to flow between computer system 132 and computer keyboard 131b when relay 103b is activated. Control signal S_{Data2} is disallowed from flowing between computer system 132 and computer keyboard 131b when relay 103b is deactivated.

It should be noted that computer mouse 131a and computer keyboard 131b can be in communication with computer system 132 in many other ways. For example, in some embodiments, computer keyboard 131b is in communication with computer system 132 through a wireless receiver and mouse 131a is in communication with computer system 132 through a cable. In should also be noted that relays 103a and 103b are activated and deactivated in response to security signal S_{Security}, as discussed above and as will be discussed in more detail presently.

In operation, signal S_{Security} is provided to relays 103a and 103b in response to the predetermined input. In response, relays 103a and 103b are activated so that signals S_{Data1} and S_{Data2} are allowed to flow, as described above. In this way, the operation of computer system 132 can be controlled in response to input signals S_{Input1} and S_{Input2} being provided to computer mouse 131a and computer keyboard 131b, respectively. Signals S_{Input1} and S_{Input2} can be of many different types, such as the activation of a mouse and keyboard button, respectively.

Signal S_{Security} is not provided to relays 103a and 103b when the predetermined input is not provided. In response, relays 103a and 103b are deactivated so that signals S_{Data1} and S_{Data2} are disallowed from flowing, as described above. In this way, the operation of computer system 132 cannot be controlled in response to input signals S_{Input1} and S_{Input2} being provided to computer mouse 131a and computer keyboard 131b, respectively. It should be noted that, in this embodiment, relays 103a and 103b are activated and deactivated together. However, in some embodiments, relays 103a and 103b can be activated and deactivated separately.

The embodiments of the invention described herein are exemplary and numerous modifications, variations and rearrangements can be readily envisioned to achieve substantially equivalent results, all of which are intended to be embraced within the spirit and scope of the invention.

1. An electronic system, comprising:
an input device;
an electronic device;
a switching device which allows and disallows, in response to a security signal, the input device to control the operation of the electronic device with a digital control signal.

2. The system of claim 1, wherein the input device is a thermostat and the electronic device is an air conditioning unit.

3. The system of claim 1, wherein the switching device is activated and deactivated in response to the security signal.

4. The system of claim 3, wherein the input device is in communication with the electronic device when the switching device is activated.

5. The system of claim 3, wherein the input device is not in communication with the electronic device when the switching device is deactivated.

6. The system of claim 3, wherein the switching device attenuates the digital control signal when it is deactivated.

7. An electronic system, comprising:
an electronic device;
an input device having input and output portions, the output portion being in communication with the electronic device; and
a switching device which is activated and deactivated in response to a security signal, the electronic device being responsive, when the switching device is activated, to a digital control signal from the output portion.

8. The system of claim 7, wherein the switching device is connected between the input and output portions.

9. The system of claim 8, wherein the input portion controls the operation of the output portion when the switching device is activated.

10. The system of claim 8, wherein the input portion does not control the operation of the output portion when the switching device is deactivated.

11. The system of claim 7, wherein the electronic device operates, when the switching device is activated, in response to a digital signal from the device input.

12. The system of claim 7, wherein the switching device is activated in response to a security signal.

13. The system of claim 7, further including a security system which provides the security signal.

14. The system of claim 12, wherein the security system is a card reader.

15. The system of claim 7, wherein the input device is a computer input device and the electronic device is a computer.

16. An electronic system, comprising:
an electronic device;
a switching device; and
an input device in digital communication with the electronic in response to the switching device being activated.

17. The system of claim 16, wherein the input device is electrically connected to the electronic device when the switching device is activated.

18. The system of claim 16, wherein the input device is electrically disconnected from the electronic device when the switching device is deactivated.

19. The system of claim 16, wherein the electronic device operates, when the switching device is activated, in response to a digital signal from the device input.

20. The system of claim 16, wherein the switching device is activated in response to a security signal.
